(19) United States
(12) Patent Application Publication
(10) Pub. No.: US 2012/0285392 A1
(43) Pub. Date: Nov. 15, 2012

(54) DEEP WATER NUTRIENT RECOVERY SYSTEM

(75) Inventors: Gaye Elizabeth Morgenthaler, Woodside, CA (US); David Vancott Jones, Woodside, CA (US)

(73) Assignee: LiveFuels, Inc., Menlo Park, CA (US)

(21) Appl. No.: 13/463,622

(22) Filed: May 3, 2012

Related U.S. Application Data
(60) Provisional application No. 61/485,868, filed on May 13, 2011.

(51) Int. Cl. A01K 61/02

(52) U.S. Cl. 119/230

(57) ABSTRACT

Disclosed herein are methods for mixing of carbon dioxide (CO₂) and/or other nutrients in an ocean, wherein surface water CO₂ is decreased to reduce or slow acidification of the ocean, and increases in fish populations are advantageously promoted. Also disclosed herein are methods and systems for recovery of nutrients, for example, phosphorus, from an ocean floor in the form of fish biomass, which may be used to make such useful products as fish fillets, fish meal, fish oil, biofuel or fertilizer.

### CROSS-REFERENCE TO RELATED APPLICATIONS

This application claims priority to U.S. Provisional Patent Application No. 61/485,868, filed May 13, 2011, which provisional application is incorporated herein by reference in its entirety. All patents and patent applications cited in this application, all related applications referenced herein, and all references cited therein are incorporated herein by reference in their entirety as if restated here in full and as if each individual patent and patent application was specifically and individually indicated to be incorporated by reference.

### 1. FIELD OF THE INVENTION

The present invention provides methods for mixing of carbon dioxide (CO₂) and/or other nutrients in an ocean, wherein surface water CO₂ is decreased to reduce or slow acidification of the ocean, and increases in fish populations are advantageously promoted. The present invention also provides methods and systems for recovery of nutrients, for example, phosphorus, from an ocean floor in the form of fish biomass, which may be used to make such useful products as fish fillets, fish meal, fish oil, biofuel or fertilizer.

### 2. BACKGROUND OF THE INVENTION

The release of fossil fuel CO₂ into the atmosphere by human activity may have contributed greatly to recent global climate change. Ocean waters are the largest natural sink of CO₂ emitted by human activities. While studies show that ocean uptake of anthropogenic CO₂ has increased sharply since the 1950s, the ability of ocean waters to absorb CO₂ appears to have decreased in recent years. Several factors have contributed to the decrease CO₂ absorption capacity of ocean water. The warming of sea surface temperatures in the Southern Ocean, the primary conduit by which CO₂ enters the ocean, has made it increasingly difficult for ocean water to absorb CO₂. Antarctic westerlies have led to oceanic overturning and the movement of carbon-rich waters to the surface around the South Pole. It is believed that such carbon rich surface waters have a reduced ability to absorb CO₂. As the ocean becomes a less efficient sink of manmade carbon over time, CO₂ emissions that remain in the atmosphere will continue to increase, resulting in further global climate change.

The reduced capacity of ocean water to absorb CO₂ is also believed due to ocean acidification caused by the increase in carbonic acid and hydrogen bicarbonate produced by ocean water reacting with CO₂. Dissolved ocean CO₂ reacts with water to form carbonic acid:

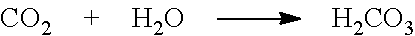

The carbonic acid dissociates, thereby releasing hydrogen ions and bicarbonate into the water:

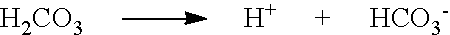

The resulting build-up of hydrogen ions in the water contributes to the acidification of the oceans.

The warming of and acidification of ocean waters are believed to be linked to decreased fish populations in particular regions. While cold-blooded animals generally respond to warming conditions by increasing growth rates as temperatures rise, evidence of slow growth rates and increased physical stress have been observed in fish populations as higher temperatures push these populations beyond their physiological limits. Ocean acidification has been shown to harm coral reefs and damage food supplies for various fish populations.

Both commercial and non-commercial overfishing have also contributed to the decrease in fish stocks in certain areas. Such overfishing not only creates a shortage in food supply and fish related products (e.g., fish oils), but also poses a threat to biodiversity with the potential to create ecological dead zones. In some instances, overfishing has led to economic hardships. For example, overfishing of Northern Cod in Newfoundland, Canada resulted in a government ban of such fishing and the loss of over 40,000 jobs.

Moreover, fish provide a mechanism for mixing of the oceans, bringing cold, nutrient-rich water from deep in the ocean to the surface, where other marine life can use the nutrients, and bringing warm, CO₂ saturated water from the surface into the ocean depths. Thus, as fish stocks decline, the ocean experiences a further reduced capacity to absorb CO₂, which further damages the fish populations.

Accordingly, there is a need for a method that increases the CO₂ absorption capacity of a region of ocean water by mixing surface water CO₂ and nutrient-rich deep water in the ocean, while advantageously promoting the increase in fish populations in the same region.

### 3. SUMMARY OF THE INVENTION

The present invention discloses methods for increasing the CO₂ absorption capacity of a body of water, for example, an ocean, by mixing surface water CO₂ and nutrient-rich deep water in the ocean. In particular, the methods disclosed herein contemplate photosynthetic conversion of the ocean surface water CO₂ into carbon biomass by culturing algae in an upwelling of a nutrient-rich source of water in the ocean, and by feeding the cultured algae to fish. These methods contemplate that an advantageous increase in the population of the algae-fed fish in the ocean will contribute to mixing of the CO₂ and/or other nutrients in the ocean through natural physical mechanisms, for example, the swimming of the fish through the ocean, and by natural organic mechanisms, for example, decomposition of the algae and fish biomass which falls back to the ocean floor as “marine snow.” The methods and systems disclosed herein also contemplate recovery of nutrients from the ocean floor, for example, phosphorus, in the form of fish biomass, which may be used to make such useful products as fish fillets, fish meal, fish oil, biofuel or fertilizer.

Accordingly, in one aspect, the present invention provides a controlled method for mixing of carbon dioxide (CO₂) and/or other nutrients in an ocean.

In certain embodiments, the method for mixing comprises: (i) providing an upwelling of a nutrient-rich source of water in the ocean; (ii) culturing algae in the upwelled water; and (iii) feeding the algae to fish; wherein the CO₂ and/or other nutrients are mixed in the ocean. In certain embodiments, the feeding of the alga to the fish increases the population of the fish in the ocean. In certain embodiments, the increase in the population of the fish in the ocean contributes to the mixing of the CO₂ and/or other nutrients in the ocean. In certain embodiments, the upwelling of the nutrient-rich source of water further contributes to the mixing of the other nutrients in the ocean. In certain embodiments, the upwelled water is provided by an open-cycle OTEC system.

In certain embodiments, the mixing of the CO₂ in the ocean by the fish decreases the concentration of CO₂ at the surface of the ocean and encourages further uptake of atmospheric CO₂ by the ocean. In certain embodiments, the culturing of algae in the upwelled water consumes CO₂ in the water and reduces or slows acidification of the ocean.

In certain embodiments, the other nutrients are selected from the group consisting of nitrogen (N), phosphorus (P), potassium (K), silicon (Si), iron (Fe), calcium (Ca), magnesium (Mg), chromium (Cr), selenium (Se), manganese (Mn), nickel (Ni), cobalt (Co), copper (Cu), and zinc (Zn).

In certain embodiments, the environment of the upwelled water is controlled by monitoring and/or adjusting one or more variables selected from the group consisting of pH, salinity, dissolved oxygen, alkalinity, nutrient concentrations, water homogeneity, temperature, turbidity, algae culture, and fish stock.

In another aspect, the present invention provides a controlled method for recovery of nutrients from an ocean floor.

In certain embodiments, the method for recovery comprises: (i) providing an upwelling of a nutrient-rich source of water in the ocean; (ii) converting CO₂ and/or other nutrients into algal biomass in the upwelled water; (iii) converting the algal biomass into fish biomass; and (iv) recovering the nutrients from the fish biomass. In certain embodiments, the upwelled nutrient-rich source of water is provided by an open-cycle OTEC system.

In certain embodiments, the fish biomass is used to make fish fillets, fish meal, fish oil, biofuel or fertilizer. In certain embodiments, the fish biomass is used make biofuel. In certain embodiments, the biofuel is used to make a liquid fuel selected from the group consisting of diesel, biodiesel, renewable diesel, kerosene, jet-fuel, gasoline, JP-1, JP-4, JP-5, JP-6, JP-7, JP-8, Jet Propellant Thermally Stable (JPTS), a Fischer-Tropsch liquid, an alcohol-based fuel, and a cellulosic biomass-based transportation fuel. In certain embodiments, the fish biomass is used make fish oil. In certain embodiments, the fish oil is used to make omega 3 fatty acids selected from the group consisting of eicosapentaenoic acid (EPA), docosahexaenoic acid (DHA), and derivatives thereof. In certain embodiments, the fish biomass is used to make fertilizer.

In certain embodiments, the nutrients recovered from the ocean floor are selected from the group consisting of N, P, K, Si, Fe, Ca, Mg, Cr, Se, Mn, Ni, Co, Cu, and Zn. In certain embodiments, the nutrient recovered from the ocean floor is P.

In certain embodiments, the decomposition of the algae and fish biomass produces marine snow which recycles the nutrients back to the ocean floor.

In certain embodiments, the conversion of CO₂ into algal biomass and/or fish biomass decreases the concentration of CO₂ in the water and reduces or slows acidification of the ocean.

In certain embodiments, the environment of the upwelled water is controlled by monitoring and/or adjusting one or more variables selected from the group consisting of pH, salinity, dissolved oxygen, alkalinity, nutrient concentrations, water homogeneity, temperature, turbidity, algae culture, and fish stock.

In another aspect, the present invention provides a controlled system for recovery of nutrients from the ocean floor.

In certain embodiments, the system comprises: (i) means for providing an upwelling of a nutrient-rich source of water; (ii) means for culturing algae in the upwelled water; (iii) means for feeding the algae to fish; and (iv) means of recovering the nutrients from the fish. In certain embodiments, the means for generating or controlling the upwelled water comprises an open-cycle OTEC system.

In certain embodiments, the system further comprises one or more enclosures containing the algae and/or the fish. In certain embodiments, the system further comprises the means to monitor and regulate the environment of the enclosures. In certain embodiments, the means to monitor and regulate the environment of the enclosures is selected from the group consisting of means to monitor and/or adjust the pH, salinity, dissolved oxygen, alkalinity, temperature, turbidity, water homogeneity, algae culture, and fish stock, and concentrations of nutrients to the enclosures.

### 4. DESCRIPTION OF THE FIGURES

FIG. 1. Method for mixing of CO₂ and/or nutrients in an ocean.

FIG. 2. Method for recovery of nutrients from ocean floor.

### 5. DETAILED DESCRIPTION OF THE INVENTION

### 5.1 Method of Mixing of Carbon Dioxide and/or Nutrients in an Ocean

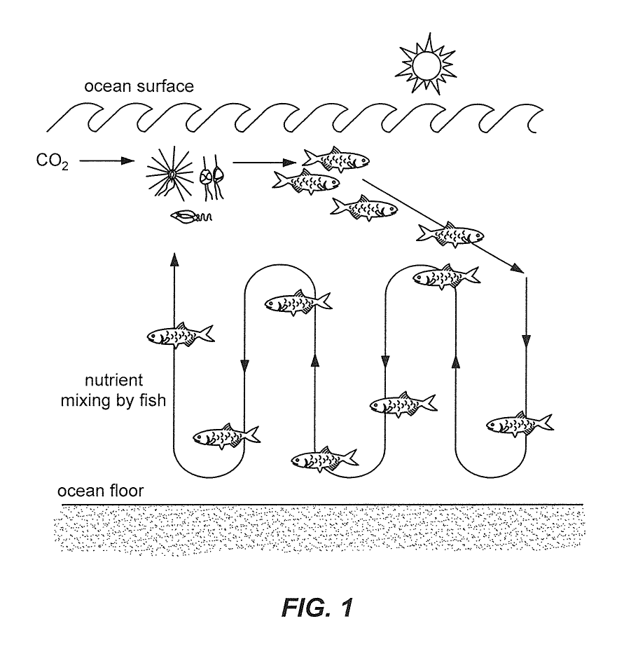

In one aspect, provided herein is a controlled method for mixing of carbon dioxide (CO₂) and/or nutrients in an ocean. In certain embodiments, the method comprises the steps of: (i) providing an upwelling of a source of water in the ocean; (ii) culturing algae in the upwelled water; and (iii) feeding the algae to fish. In certain embodiments, the source of water is nutrient-rich. See, e.g., FIG. 1. In certain embodiments, the feeding of algae to the fish increases the population of the fish in the ocean. See, e.g., FIG. 1. In certain embodiments, the increase in the population of the fish in the ocean contributes to the mixing of the CO₂ and/or other nutrients in the ocean. See, e.g., FIG. 1. Without intending to be bound by any particular theory, it is believed that an increase in the population of fish in the ocean will contribute to the mixing of the CO₂ from the surface of the ocean to the lower depths of the ocean by natural physical mechanisms, for example, the swimming of the fish through the ocean, and/or by natural organic mechanisms, for example, decomposition of the algae and fish biomass which falls back to the ocean floor as “marine snow.”

5.1.1 Upwelling and Nutrients

In certain embodiments, nutrients from the lower depths of the ocean are vertically mixed into shallower ocean waters through an upwelling. Upwelling of nutrient rich water from lower depths of the ocean can be achieved using any method know to one of ordinary skill in the art.

In certain embodiments, the upwelling of nutrient rich water is achieved using any man-made devices that are present in or installed in a body of water to modify a flow of water, such that nutrient-rich water from a source is directed towards a target. Non-limiting examples of such man-made devices are mechanical objects that are installed or abandoned on the sea floor (also known as “hangs”), many of which become obstructions to shipping and oil/gas exploration. Such objects can be relocated to and/or aggregated at one or more locations on the sea floor to modify one or more currents in a body of water. Other man-made devices provided herein include but are not limited to a network of pipelines, risers, and platforms that are installed for exploration and production of oil and/or natural gas and that can be modified for the purpose of certain embodiments by one of ordinary skill in the art.

In certain embodiments, the upwelling of nutrient rich water from the lower depths of the ocean to high depths is achieved using Ocean Thermal Energy Conversion (“OTEC”) systems. OTEC systems produce energy by exploiting the temperature difference between thermoclines, e.g., the warm surface water and the cold water in deeper ocean strata. OTEC systems can be closed- or open-cycle; in the former an enclosed environment pumps liquid between the thermal zones, whereas in the latter the cold water is brought up from the depths and released near the ocean surface. Typically an open-cycle OTEC system includes a shore- or barge-mounted plant and a large diameter cold water pipe. Cold water from the ocean depths is pumped to the surface through the cold water pipe. The cold water is then directed into a power module that also receives warm water from the surface. The temperature differential between the cold water and warm water then generates electric energy through well-known techniques such as Rankine cycle-based power generation. OTEC systems are more thoroughly described in multiple literature references such as those by Vega (Vega, L. A., “Ocean Thermal Energy Conversion Primer,” Mar Technol Soc J, 6: 25-35.) and from the Coastal Response Research Center (2010, Technical Readiness of Ocean Thermal Energy Conversion (OTEC)).

The relatively large temperature differential required for efficient OTEC operation (typically at least 20° C.) means the OTEC system will operate in water depths that may be 3,000 feet, more or less. Since the source depth of a desired upwelling may correspond to that required for operation of the OC-OTEC, in certain embodiments an open-cycle OTEC system will provide the nutrients that will stimulate growth of algae in the target depth of the body of water.

Exemplary OTEC systems and methods of sourcing nutrient rich water from the lower depths of the ocean are described in U.S. Provisional Application No. 61/483,376, filed May 6, 2011, which is incorporated herein by reference in its entirety.

Upwelled water is often rich in nutrients. In certain embodiments of the methods provided herein, the upwelled water comprises any nutrient that could provide for the growth and nourishment of algae. In certain embodiments, the upwelled nutrient comprises carbon (C), nitrogen (N), phosphorus (P), potassium (K), silicon (Si), iron (Fe), calcium (Ca), magnesium (Mg), chromium (Cr), selenium (Se), manganese (Mn), nickel (Ni), cobalt (Co), copper (Cu), or zinc (Zn), or combinations thereof. In certain embodiments, the upwelled nutrient comprises N, P, K and/or Si, or combinations thereof.

The present invention contemplates that phosphorus (P), along with nitrogen (N) and potassium (K), is important for algal growth. Accordingly, in specific embodiments, the upwelled water comprises N, P and/or K, or combinations thereof. In preferred embodiments, the upwelled water comprises P.

5.1.2 Culturing of Algae

In certain aspects of the methods and systems provided herein, nutrients contained within the upwelled source of water and CO₂ in the surface ocean water will be absorbed and processed by algae cultured in the upwelled source of water.

As used herein the term “algae” refers to any organisms with chlorophyll and a thallus not differentiated into roots, stems and leaves, and encompasses prokaryotic and eukaryotic organisms that are photoautotrophic or photoauxotrophic. The term “algae” includes macroalgae (commonly known as seaweed) and microalgae. For certain embodiments of the invention, algae that are not macroalgae are preferred. The terms “microalgae” and “phytoplankton,” used interchangeably herein, refer to any microscopic algae, photoautotrophic or photoauxotrophic eukaryotes (such as, protozoa), photoautotrophic or photoauxotrophic prokaryotes, and cyanobacteria (commonly referred to as blue-green algae and formerly classified as Cyanophyceae). The use of the term “algal” also relates to microalgae and thus encompasses the meaning of “microalgal.” The term “algal composition” refers to any composition that comprises algae, such as an aquatic composition, and is not limited to the body of water or the culture in which the algae are cultivated. An algal composition can be an algal culture, a concentrated algal culture, or a dewatered mass of algae, and can be in a liquid, semi-solid, or solid form. A non-liquid algal composition can be described in terms of moisture level or percentage weight of the solids. An “algal culture” is an algal composition that comprises live algae.

The microalgae of the methods provided herein are also encompassed by the term “plankton” which includes phytoplankton, zooplankton and bacterioplankton. For certain embodiments of the invention, an algal composition or a body of water comprising algae that is substantially depleted of zooplankton is preferred since many zooplankton consume phytoplankton. However, it is contemplated that many aspects of the invention can be practiced with a planktonic composition, without isolation of the phytoplankton, or removal of the zooplankton or other non-algal planktonic organisms. The methods of the invention can be used with a composition comprising plankton, or a body of water comprising plankton.

The algae used in the methods provided herein can be a naturally occurring species, a genetically selected strain, a genetically manipulated strain, a transgenic strain, or a synthetic algae. Preferably, the algae bears at least a beneficial trait, such as but not limited to, increased growth rate, lipid accumulation, favorable lipid composition, adaptation to the culture environment, and robustness in changing environmental conditions. It is desirable that the algae accumulate excess lipids and/or hydrocarbons. However, this is not a requirement because the algal biomass, without excess lipids, can be converted to lipids metabolically by the harvesting fish. The algae in an algal composition of the invention may not all be cultivable under laboratory conditions. It is not required that all the algae in an algal composition of the invention be taxonomically classified or characterized in order for the composition be used in the present invention. Algal compositions, including algal cultures, can be distinguished by the relative proportions of taxonomic groups that are present.

The algae used in the methods provided herein use light as its energy source. The algae can be grown under the sunlight or artificial light. In addition to using mass per unit volume (such as mg/l or g/l), chlorophyll a is a commonly used indicator of algal biomass. However, it is subjected to variability of cellular chlorophyll content (0.1 to 9.7% of fresh algal weight) depending on algal species. An estimated biomass value can be calibrated based on the chlorophyll content of the dominant species within a population. Published correlation of chlorophyll a concentration and biomass value can be used in the invention. Generally, chlorophyll a concentration is to be measured within the euphotic zone of a body of water. The euphotic zone is the depth at which the light intensity of the photosynthetically active spectrum (400-700 nm) exceeds 1% of the surface light intensity.

Depending on the latitude of a site, algae obtained from tropical, subtropical, temperate, polar or other climatic regions are used in the invention. Endemic or indigenous algal species are generally preferred over introduced species where an open culturing system is used. Endemic or indigenous algae may be enriched or isolated from local water samples obtained at or near the site of the system. It is advantageous to use algae and fish from a local aquatic trophic system in the methods of the invention. Algae, including microalgae, inhabit many types of aquatic environment, including but not limited to freshwater (less than about 0.5 parts per thousand (ppt) salts), brackish (about 0.5 to about 31 ppt salts), marine (about 31 to about 38 ppt salts), and briny (greater than about 38 ppt salts) environment. Any of such aquatic environments, freshwater species, marine species, and/or species that thrive in varying and/or intermediate salinities or nutrient levels, can be used in the invention. The algae in an algal composition of the invention can be obtained initially from environmental samples of natural or man-made environments, and may contain a mixture of prokaryotic and eukaryotic organisms, wherein some of the species may be unidentified. Freshwater filtrates from rivers, lakes; seawater filtrates from coastal areas, oceans; water in hot springs or thermal vents; and lake, marine, or estuarine sediments, can be used to source the algae. The samples may also be collected from local or remote bodies of water, including surface as well as subterranean water.

One or more species of algae are present in the algal composition of the invention. In one embodiment of the invention, the algal composition is a monoculture, wherein only one species of algae is grown. However, in many open culturing systems, it may be difficult to avoid the presence of other algae species in the water. The inventors believe that an algae consortium can be more productive and healthier than a monoculture. Accordingly, a monoculture may comprise about 0.1% to 2% cells of algae species other than the intended species, i.e., up to 98% to 99.9% of the algal cells in a monoculture are of one species. In certain embodiments, the algal composition comprises an isolated species of algae, such as an axenic culture. In another embodiment, the algal composition is a mixed culture that comprises more than one species of algae, i.e., the algal culture is not a monoculture. Such a culture can be prepared by mixing different algal cultures or axenic cultures. In certain embodiments, the algal composition can also comprise zooplankton, bacterioplankton, and/or other planktonic organisms. In certain embodiments, an algal composition comprising a combination of different batches of algal cultures is used in the invention. The algal composition can be prepared by mixing a plurality of different algal cultures. The different taxonomic groups of algae can be present in defined proportions. The combination and proportion of different algae in an algal composition can be designed or adjusted to enhance the growth and/or accumulation of lipids of certain groups or species of fish. A microalgal composition of the invention can comprise predominantly microalgae of a selected size range, such as but not limited to, below 2000 μm, about 200 to 2000 μm, above 200 μm, below 200 μm, about 20 to 2000 μm, about 20 to 200 μm, above 20 μm, below 20 μm, about 2 to 20 μm, about 2 to 200 μm, about 2 to 2000 μm, below 2 μm, about 0.2 to 20 μm, about 0.2 to 2 μm or below 0.2 μm.

A mixed algal composition of the methods provided herein comprises one or several dominant species of macroalgae and/or microalgae. Microalgal species can be identified by microscopy and enumerated by counting visually or optically, or by techniques such as but not limited to microfluidics and flow cytometry, which are well known in the art. A dominant species is one that ranks high in the number of algal cells, e.g., the top one to five species with the highest number of cells relative to other species. Microalgae occur in unicellular, filamentous, or colonial forms. The number of algal cells can be estimated by counting the number of colonies or filaments. Alternatively, the dominant species can be determined by ranking the number of cells, colonies and/or filaments. This scheme of counting may be preferred in mixed cultures where different forms are present and the number of cells in a colony or filament is difficult to discern. In a mixed algal composition, the one or several dominant algae species may constitute greater than about 10%, about 20%, about 30%, about 40%, about 50%, about 60%, about 70%, about 80%, about 90%, about 95%, about 97%, about 98% of the algae present in the culture. In certain mixed algal composition, several dominant algae species may each independently constitute greater than about 10%, about 20%, about 30%, about 40%, about 50%, about 60%, about 70%, about 80% or about 90% of the algae present in the culture. Many other minor species of algae may also be present in such composition but they may constitute in aggregate less than about 50%, about 40%, about 30%, about 20%, about 10%, or about 5% of the algae present. In various embodiments, one, two, three, four, or five dominant species of algae are present in an algal composition. Accordingly, a mixed algal culture or an algal composition can be described and distinguished from other cultures or compositions by the dominant species of algae present. An algal composition can be further described by the percentages of cells that are of dominant species relative to minor species, or the percentages of each of the dominant species. The identification of dominant species can also be limited to species within a certain size class, e.g., below 2000 μm, about 200 to 2000 μm, above 200 μm, below 200 μm, about 20 to 2000 μm, about 20 to 200 μm, above 20 μm, below 20 μm, about 2 to 20 μm, about 2 to 200 μm, about 2 to 2000 μm, below 2 μm, about 0.2 to 20 μm, about 0.2 to 2 μm or below 0.2 μm. It is to be understood that mixed algal cultures or compositions having the same genus or species of algae may be different by virtue of the relative abundance of the various genus and/or species that are present.

It is contemplated that many different algal cultures or bodies of water that comprise plankton, can be harvested efficiently by the methods provided herein. Microalgae are preferably used in many embodiments of the invention; while macroalgae are less preferred in certain embodiments. In specific embodiments, algae of a particular taxonomic group, e.g., a particular genera or species, may be less preferred in a culture. Such algae, including one or more that are listed below, may be specifically excluded as a dominant species in a culture or composition. However, it should also be understood that in certain embodiments, such algae may be present as a contaminant, a non-dominant group or a minor species, especially in an open system. Such algae may be present in negligent numbers, or substantially diluted given the volume of the culture or composition. The presence of such algal genus or species in a culture, composition or a body of water is distinguishable from cultures, composition or bodies of water where such algal genus or species are dominant, or constitute the bulk of the algae. The composition of an algal culture or a body of water in an open culturing system is expected to change according to the four seasons, for example, the dominant species in one season may not be dominant in another season. An algal culture at a particular geographic location or a range of latitudes can therefore be more specifically described by season, i.e., spring composition, summer composition, fall composition, and winter composition; or by any one or more calendar months, such as but not limited to, from about December to about February, or from about May to about September. The species composition of an algal culture or a body of water in an open culturing system can also be modified by changing the chemical composition of the water, including but not limited to, nutrient concentrations (N/P/Si), pH, alkalinity, and salinity. The degree of mixing in the pond can also be used to control the algae consortium. Given the remarkable specialization of algae species to environmental conditions, the dominant species can vary diurnally, seasonally, and even within a pond.

Exemplary species compositions of algal cultures are described in U.S. Provisional Application No. 61/483,316, filed May 6, 2011, which is incorporated herein by reference in its entirety.

The instant invention also contemplates methods for controlling the growth of the algal culture. Exemplary methods and systems for controlling the growth of the algal culture are described in U.S. Provisional Application No. 61/483,316.

Accordingly, in another aspect, the methods comprise providing one or more species of algae to a target site, such that the algae can consume the nutrients brought by an upwelling at the target site. In certain embodiments, without the upwelling, the water at a target site is oligotrophic and comprises mostly picoplankton and nanoplankton, such as Prochlorococcus and Synechococcus, that are in the size range of 0.2 to 2 micrometer. There are few planktivorous fish that can efficiently filter plankton in this size range. Other algae are only present at a low level at the target site and may take a period of time to expand in numbers. In certain embodiments, the algae are selected according to their abilities to assimilate efficiently the nutrients transferred by an upwelling to the target site, taking into account the nutrient profile of the site over a period of time. In certain embodiments, the algae are also selected according to their suitability as food for the planktivorous organisms provided herein for harvesting. For example, it is desirable that the size of the algae matches the filter-feeding abilities of the planktivorous organisms.

Depending on their initial concentrations, one or more of the other nutrients, such as C, N, P, K, Si, and Fe, can become depleted as they are consumed by the cultured algae. Since different organisms have different nutrient requirements and growth rates, it is expected that a nutrient can be depleted and become limiting for certain groups of organisms and not limiting for others. Such a condition can select for organisms that are less dependent on the depleted nutrient. Organisms experiencing nutrient limitation are at a growth disadvantage relative to other organisms. For example, nitrogen-fixing organisms, such as cyanobacteria, are favorably selected in a body of water that is nitrogen-limiting. Silicon is required for the growth of diatoms. In certain embodiments, as limiting nutrients affect significantly the primary and secondary productivities of a body of water, the methods and systems provide upwelled water and/or added nutrients to prevent or overcome nutrient limitation at a target site, and/or to steer the growth of a population of algae so that algal species that are preferably consumed by the fish provided herein become the major species in the growing population. Nutrients that can be added to the algal culture include micronutrients, such as inorganic salts comprising Si, Fe, Ca, Zn, Mn, B, Mo, Mg, V, Sr, Al, Rb, Li, Cu, Co, Br, I, and Se.

5.1.3 Feeding of Cultured Algae to Fish

In certain aspects of the methods and systems provided herein, the cultured algae will be fed to fish.

As used herein, the term fish refers to a member or a group of the following classes: Actinopteryii (i.e., ray-finned fish) which includes the division Teleosteri (also known as the teleosts), Chondrichytes (e.g., cartilaginous fish), Myxini (e.g., hagfish), Cephalospidomorphi (e.g., lampreys), and Sarcopteryii (e.g., coelacanths). The teleosts comprise at least 38 orders, 426 families, and 4064 genera. Some teleost families are large, such as Cyprimidae, Gobiidae, Cichlidae, Characidae, Loricariidae, Balitoridae, Serranidae, Labridae, and Scorpaenidae. In many embodiments, the invention involves bony fish, such as the teleosts, and/or cartilaginous fish. When referring to a plurality of organisms, the term “fish” is used interchangeably with the term “fish” regardless of whether one or more than one species are present, unless clearly indicated otherwise.

Stocks of fish, obtained initially from fish hatcheries or collected from the wild may also be used in the methods provided herein. In some embodiments, the fish population comprises cultured or farmed fish. The fish may be fish fry, juveniles, fingerlings, or adult/mature fish. In certain embodiments of the invention, fry and/or juveniles that have metamorphosed are used. By “fry,” it is meant a recently hatched fish that has fully absorbed its yolk sac, while by “juvenile” or “fingerling,” it is meant a fish that has not recently hatched but is not yet an adult. In certain embodiments, the fish may reproduce in an enclosure comprising algae within the system and not necessarily in a fish hatchery. Any fish aquaculture techniques known in the art can be used to stock, maintain, reproduce, and gather the fish used in the invention.

Fish inhabits most types of aquatic environment, including but not limited to freshwater, brackish, marine, and briny environments. As the present invention can be practiced in any of such aquatic environments, any freshwater species, stenohaline species, euryhaline species, marine species, species that grow in brine, and/or species that thrive in varying and/or intermediate salinities, can be used. Depending on the latitude of the system, fish from tropical, subtropical, temperate, polar, and/or other climatic regions can be used. For example, fish that live within the following temperature ranges can be used: below 10° C., 9° C. to 18° C., 15° C. to 25° C., 20° C. to 32° C. In one embodiment, fish indigenous to the region at which the methods of the invention are practiced, are used. Preferably, fish from the same climatic region, same salinity environment, or same ecosystem, as the algae are used. The algae and the fish are preferably derived from a naturally occurring trophic system.

In an aquatic ecosystem, fish occupies various trophic levels. Depending on diet, fish are classified generally as piscivores (carnivores), herbivores, planktivores, detritivores, and omnivores. The classification is based on observing the major types of food consumed by fish and its related adaptation to the diet. For example, many species of planktivores develop specialized anatomical structures to enable filter feeding, e.g., gill rakers and gill lamellae. Generally, the size of such filtering structures relative to the dimensions of plankton, including microalgae, affects the diet of a planktivore. Fish having more closing spaced gill rakers with specialized secondary structures to form a sieve are typically phytoplanktivores. Others having widely spaced gill rakers with secondary barbs are generally zooplanktivores. In the case of piscivores, the gill rakers are generally reduced to barbs. Herbivores generally feed on macroalgae and other aquatic vascular plants. Gut content analysis can determine the diet of an organism used in the invention. Techniques for analysis of gut content of fish are known in the art. As used herein, a planktivore is a phytoplanktivore if a population of the planktivore, reared in water with non-limiting quantities of phytoplankton and zooplankton, has on average more phytoplankton than zooplankton in the gut, for example, greater than 50%, 60%, 70%, 80%, or 90%. Under similar conditions, a planktivore is a zooplantivore if the population of the planktivore has on average more zooplankton than phytoplankton in the gut, for example, greater than 50%, 60%, 70%, 80%, or 90%. Certain fish can consume a broad range of food or can adapt to a diet offered by the environment. Accordingly, it is preferable that the fish are cultured in a system of the invention before undergoing a gut content analysis.

Fish that are used in the methods of the invention feed on algae, but it is not required that they feed exclusively on microalgae, i.e., they can be herbivores, omnivores, planktivores, phytoplanktivores, zooplanktivores, or generally filter feeders, including pelagic filter feeders and benthic filter feeders. In some embodiments of the invention, the population of fish useful for harvesting algae comprises predominantly planktivores. In some embodiments of the invention, the population of fish useful for harvesting algae comprises predominantly omnivores. In certain embodiments, one or several major species in the fish population are planktivores or phytoplanktivores. In certain mixed fish population of the invention, planktivores and omnivores are both present. In certain other mixed fish population, in addition to planktivores, herbivores and/or detritivores are also present. In certain embodiments, piscivores are used in a mixed fish population to harvest other fish. In certain embodiments, piscivores are less preferred or excluded from the systems of the invention. The predominance of one type of fish as defined by their trophic behavior over another type in a population of fish can be defined by percentage head count as described above for describing major fish species in a population (e.g., 90% phytoplanktivores, 10% omnivores).

The choice of fish for use in the harvesting methods of the invention depends on a number of factors, such as the palatability and nutritional value of the cultured algae as food for the fish, the lipid composition and content of the fish, the feed conversion ratio, the fish growth rate, and the environmental requirements that encourages feeding and growth of the fish. For example, it is preferable that the selected fish will feed on the cultured algae until satiation, and convert the algal biomass into fish biomass rapidly and efficiently. Gut content analysis can reveal the dimensions of the plankton ingested by a planktivore and the preference of the planktivore for certain species of algae. Knowing the average dimensions of ingested plankton, the preference and efficiency of a planktivore towards a certain size class of plankton can be determined. Based on size preference and/or species preference of the fish, a planktivore can be selected to match the size and/or species of algae in the algal composition. To reduce the need to change water when an algae composition is brought to the fish in an enclosure, the algae and fish are preferably adapted to grow in a similar salinity environment. The use of matched fish and algae species in the methods of the invention can improve harvesting efficiency. It may also be preferable to deploy combinations of algae and fish that are parts of a naturally occurring trophic system. Many trophic systems are known in the art and can be used to guide the selection of algae and fish for use in the invention. In various embodiments, the population of fish can be self-sustaining and does not require extensive fish husbandry efforts to promote reproduction and to rear the juveniles. In various other embodiments, the population of fish may require extensive fish husbandry efforts to promote reproduction and to rear the juveniles. For example, one of ordinary skill in the art will appreciate that where the fish are planktivorous, such filter-feeders might filter out and eat their own eggs inadvertently.

It should be understood that, in various embodiments, fish within a taxonomic group, such as a family or a genus, can be used interchangeably in various methods of the invention. The invention is described below using common names of fish groups and fish, as well as the scientific names of exemplary species. Databases, such as FishBase by Froese, R. and D. Pauly (Ed.), World Wide Web electronic publication, www.fishbase.org, version (06/2008), provide additional useful fish species within each of the taxonomic groups that are useful in the invention. It is contemplated that one of ordinary skill in art could, consistent with the scope of the present invention, use the databases to specify other species within each of the described taxonomic groups for use in the methods of the invention.

Exemplary fish populations, fish stock and fish species, and methods and systems for controlling the feeding of the algal culture to the fish are described in U.S. Provisional Application No. 61/483,316, filed May 6, 2011.

5.1.4 Mixing of CO₂ and/or Other Nutrients

In certain aspect aspects of the methods and systems provided herein, the increased in the population of the fish in the ocean contributes to the mixing of the CO₂ and/or other nutrients in the ocean.

As used herein, the term “mixing” as in “mixing of the ocean” refers to the process by which various layers of water interact with one another to distribute heat, nutrients, and gasses throughout the oceans. Mixing of the various layers of the ocean waters may occur by any mechanism understood by one of ordinary skill in the art. In certain embodiments, mixing occurs by one or more of the following mechanisms: wind action, tide action, currents, biogenic mixing, turbulent wake mixing and/or Darwinian mixing.

In certain embodiments, mixing occurs through biogenic mixing caused by turbulence generated by the movement of the population of fish described herein as they swim through the ocean water. Some studies estimate that the global contribution of oceanic mixing due to swimming animals is equal to the contribution provided by physical processes such as winds and tides. See, e.g., Katija and Dabiri, 2009, Nature 460: 624-627. Accordingly, one of ordinary skill in the art would understand that swimming animals, for example, fish, can be responsible for up to ⅓ of all oceanic mixing. Without intending to be bound by any particular theory, it is believed that the turbulence created by the swimming of the population of fish described herein through oceanic water creates sufficient turbulence throughout the water to mix CO₂ and/or other nutrients, including upwelled nutrients, from the surface of the ocean water to the lower depths.

In certain embodiments of the methods and systems described herein, the mixing of CO₂ and/or other nutrients occurs through natural organic mechanisms, for example, decomposition of the algae and fish biomass which falls back to the ocean floor as “marine snow.”

### 5.2 Method of Recovery of Nutrients from an Ocean Floor

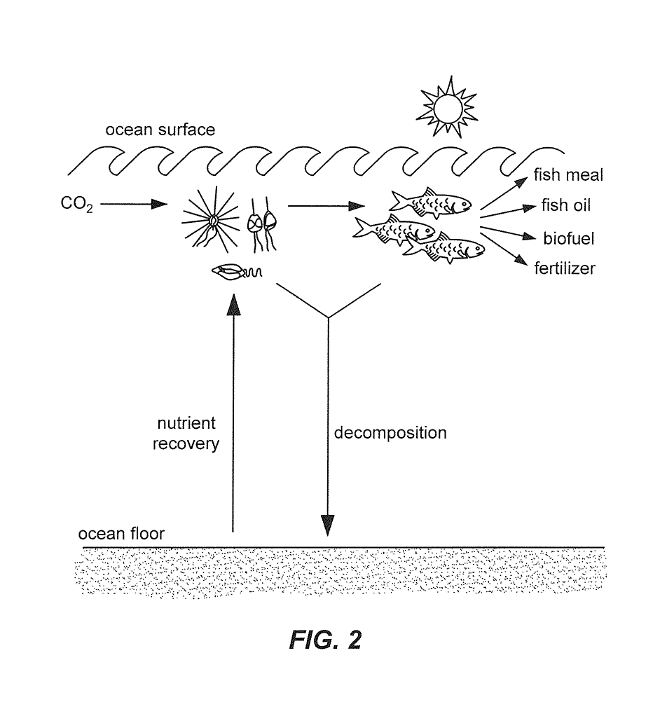

In another aspect provided herein is a controlled method that allow for the recovery of nutrients from an ocean floor. In certain embodiments the method comprises the steps of: (i) providing an upwelling of a nutrient-rich source of ocean water by using an open-cycle OTEC system; (ii) converting CO₂ and/or nutrients into algal biomass in the upwelled water; (iii) converting the algal biomass into fish biomass; and (iv) recovering the nutrients from the fish biomass. See, e.g., FIG. 2. In certain embodiments, the nutrients are recovered from the fish biomass in the form of fish fillets, fish meal, fish oil, biofuel or fertilizer. See, e.g., FIG. 2. In certain embodiments, nutrients that are not recovered through the harvesting of fish biomass are recycled back to the ocean depths as algal and fish biomass decompose or as the “marine snow” produced by the fish biomass. See, e.g., FIG. 2.

The term “ocean floor” refers to the bottom of a sea or ocean. One of ordinary skill in the art will understand that the ocean floor may be covered with a layer or sediment of inorganic and organic nutrients. This layer or sediment may be caused, in part, by the particulate waste product of bodies of dead organisms as these sink into and enrich deeper water in the aphotic zone. This layer or sediment may also be caused, in part, by the accumulation of minerals in situ on the sea floor, depending on local geochemical conditions, including elemental abundances, water characteristics, proximity of hydrothermal sources, and rate of sediment accumulation. Due to the paucity of mixing between surface water and denser water in the deep layer, many nutrients are deposited and accumulated near or at the bottom of a water column. Upwelled water derived from greater depth is thus richer with nutrients than surface water.

In certain embodiments, the step of providing an upwelling of a nutrient rich source of ocean water can be performed according to the methods described in Section 5.1.1 supra. In certain embodiments, the step of providing an upwelling of a nutrient-rich source of water is performed using an open-cycle OTEC system.

In certain embodiments, the nutrient rich source of ocean water comprises any of the nutrients described in Section 5.1.2 supra. In certain embodiments, the upwelled source of ocean water comprises N, P, K and/or Si, or combinations thereof. In certain embodiments, the nutrient source of water comprises P.

5.2.1 Conversion of CO₂ and/or Nutrients into Algal Biomass and Fish Biomass

In certain aspects of the methods and systems described herein, CO₂ from the surface ocean water and/or nutrients from the upwelled water is converted into algal biomass. In certain aspects of the methods and systems described herein, algal biomass comprising converted CO₂ from the surface ocean water and/or nutrients from the upwelled water is converted into fish biomass.

In certain embodiments, the conversion of algal biomass into fish biomass is performed by feeding the algae to fish. The feeding of algae to fish encompasses any methods by which the algae and fish of the invention are brought into proximity of each other such that the fish can ingest the algae. Preferably, the algae is accessible to the fish in an energy-efficient and controlled manner. The algae in an algal composition can be added to, pumped into, or allowed to flow into an enclosure in which the fish are held. An algal composition can be made available to the fish in batches or on a continuous basis. The algae can be distributed throughout the fish enclosure by any means, such as but not limited to agitation or aeration of the enclosure. The algae can also be dispensed at multiple locations in the fish enclosure. The algae can be distributed by water current in the enclosure in which the fish swim through. Exemplary methods and systems for controlled feeding of the algae to fish, optionally in enclosures, are described in U.S. Provisional Application No. 61/483,316, filed May 6, 2011.

5.2.2 Recovery of Nutrients from Fish Biomass

In certain embodiments of the methods and systems described herein, the nutrients from the fish biomass are recovered. Recovery of nutrients from fish biomass can be performed by any technique known to one of ordinary skill in the art. In certain embodiments, recovery of nutrients from fish biomass comprises a step of gathering and harvesting the fish biomass. Harvested fish mass can be subsequently converted into fish fillets, fish meal, fish oil, biofuel or fertilizer.

The fish can be gathered or harvested by any methods or means known in the art. In some embodiments, a fish gathering or capturing means is configured to separate fish based on a selected physical characteristic, such as density, weight, length, or size. The harvesting systems of the invention comprise means to gather or capture fish, which can be mechanical, pneumatic, hydraulic, electrical, or a combination of mechanisms. In one embodiment, the fish gathering device is a net that is either automatically or manually drawn through the water in order to gather or capture the fish. The net, with fish therein, can then be withdrawn from the pond. Alternately, a fish gathering device can comprise traps, or circuits for applying DC electrical pulses to the water. See, e.g., Chapters 17 and 19 in Aquaculture Engineering, Odd-Ivar Lekang, 2007, Blackwell Publishing Ltd., for description of techniques and means for moving and grading fish.

Any fish processing technologies and means known in the art can be applied to obtain the nutrients from the fish.

In one embodiment of the invention, the fish is processed and/or shipped for human consumption. The fish may be processed using any technique known to one of ordinary skill in the art. See, e.g., Hall G M (1997) “Fish processing technology,” Springer; and Luten J B, Jacobsen C and Bekaert K (2006) “Seafood research from fish to dish: quality, safety and processing of wild and farmed fish,” Wageningen Academic Publishers.

In certain embodiments, the fresh fish is shipped whole or “fresh frozen” to a particular destination, for example, a restaurant, for human consumption.

In another embodiment of the invention, the entire fish is processed to extract lipids without separating the fish fillet from other parts of the fish that are regarded as fish waste in the seafood industry. In another embodiment, only certain part(s) of the fish are used, e.g., non-fillet parts of a fish, fish viscera, head, liver, guts, testes, and/or ovary. Prior to being processed, the fish of the invention are not treated to prevent or remove off-flavor taste of the flesh. The treatment may include culturing the fish for a period from one day up to two weeks in an enclosure that has a lower algae and/or bacteria count than the fish enclosure.

Described below is an example of a method for processing the fish of the invention. The processing step involves heating the fish to greater than about 70° C., 80° C., 90° C. or 100° C., typically by a steam cooker, which coagulates the protein, ruptures the fat deposits and liberates lipids and oil and physicochemically bound water, and; grinding, pureeing and/or pressing the fish by a continuous press with rotating helical screws. The fish can be subjected to gentle pressure cooking and pressing which use significantly less energy than that is required to obtain lipids from algae. The coagulate may alternatively be centrifuged. This step removes a large fraction of the liquids (press liquor) from the mass, which comprises an oily phase and an aqueous fraction (stickwater). The separation of press liquor can be carried out by centrifugation after the liquor has been heated to 90° C. to 95° C. Separation of stickwater from oil can be carried out in vertical disc centrifuges. To obtain fishmeal, the separated water is evaporated to form a concentrate (fish solubles) that is combined with the solid residues, and then dried to solid form (presscake). The dried material may be grinded to a desired particle size. The fishmeal typically comprises mostly proteins (up to 70%), ash, salt, carbohydrates, and oil (about 5-10%). The fishmeal can be used as animal feed.

In another embodiment of the invention, the fishmeal is subjected to a hydrothermal process that extracts residual lipids, both neutral and polar. A large proportion of polar lipids, such as phospholipids, remain with the fishmeal. The hydrothermal process of the invention generally comprises treating fishmeal with near-critical or supercritical water under conditions that can extract polar lipids from the fishmeal and/or hydrolyze polar lipids resulting in fatty acids. The fishmeal need not be dried as the moisture in the fishmeal can be used in the process. The process comprises applying pressure to the fish to a predefined pressure and heating the fishmeal to a predefined temperature, wherein lipids in the fishmeal are extracted and/or hydrolyzed to form fatty acids. The fishmeal can be held at one or more of the preselected temperature(s) and preselected pressure(s) for an amount of time that facilitates, and preferably maximizes, hydrolysis and/or extraction of various types of lipids. The term “subcritical” or “near-critical water” refers to water that is pressurized above atmospheric pressure at a temperature between the boiling temperature (100° C. at 1 atm) and critical temperature (374° C.) of water. The term “supercritical water” refers to water above its critical pressure (218 atm) at a temperature above the critical temperature (374° C.). In some embodiments, the predefined pressure is between 5 atm and 500 atm. In some embodiments, the predefined temperature is between 100° C. and 500° C. or between 325° C. and 425° C. The reaction time can range between 5 seconds and 60 minutes. For example, fishmeal can be exposed to a process condition comprising a temperature of about 300° C. at about 80 atm for about 10 minutes. The selection of an appropriate set of process conditions, i.e., combinations of temperature, pressure, and process time can be determined by assaying the quantity and quality of lipids and free fatty acids, e.g., neutral lipids, phospholipids and free fatty acids, that are produced. The process further comprises separating the treated fishmeal into an organic phase which includes the lipids and/or fatty acids, an aqueous phase, and a solid phase.

In certain embodiments, harvested fish biomass is converted into fish oil. Exemplary methods and systems of using fish biomass for the production of fish oil and/or fish lipids are described in U.S. Provisional Application No. 61/483,376, filed May 6, 2011, and International Patent Publication Nos. WO 2010/036333 and WO 2010/141794, each of which is incorporated herein by reference its entirety.

In certain embodiments the fish oil is used to make omega 3 fatty acids selected from the group consisting of eicosapentaenoic acid (EPA), docosahexaenoic acid (DHA), and derivatives thereof.

In another embodiment, fish biomass is used to make fuel. In certain embodiments, fish biomass is used to make biofuel. Fish biomass can be used to make fuel and/or biofuel using any technique known to one of ordinary skill in the art. Exemplary methods and systems of using fish biomass for the production of biofuel are described in U.S. Provisional Application No. 61/483,316, filed May 6, 2011, and International Patent Publication Nos. WO 2010/036333 and WO 2010/141794, each of which is incorporated herein by reference its entirety.

Products provided herein made by the processing of fish-derived fuel or biofuel feedstocks can be incorporated or used in a variety of liquid fuels including but not limited to, diesel, biodiesel, kerosene, jet-fuel, gasoline, JP-1, JP-4, JP-5, JP-6, JP-7, JP-8, Jet Propellant Thermally Stable (JPTS), Fischer-Tropsch liquids, alcohol-based fuels including ethanol-containing transportation fuels, other biomass-based liquid fuels including cellulosic biomass-based transportation fuels.

In certain embodiments the fish biomass is used to make a liquid fuel selected from the group consisting of diesel, biodiesel, renewable diesel, kerosene, jet-fuel, gasoline, JP-1, JP-4, JP-5, JP-6, JP-7, JP-8, Jet Propellant Thermally Stable (JPTS), a Fischer-Tropsch liquid, an alcohol-based fuel, and a cellulosic biomass-based transportation fuel.

In another embodiment, harvested fish biomass is converted into fertilizers comprising phosphorus. It will be understood by one of ordinary skill in the art that supplies of non-renewable phosphate rock, the main source of phosphorus, are limited geographically. While various studies have reached different conclusions as to whether or not world phosphate reserves are dwindling in amount and quality, recent studies indicate that overall global consumption of phosphorus containing fertilizer increased by an estimated 31% from 1996 to 2009, driven by a 56% increase in developing countries. See, e.g., IFDC Press Release, September 2010, at http://www.ifdc.org/Media_Info/Press_Releases/September_{—}2010/IFDC_Report_Indicates_Adequate_Phosphorus_Resource. The U.S. Biomass Roadmap set forth a goal that by the year 2030 biomass will supply energy approximately equivalent to 30% of current petroleum consumption. See U.S. Department of Energy, “Energy Efficiency & Renewable Energy BioMass Program,” at http://www1.eere.energy.gov/biomass/pdfs/algal_biofuels_roadmap.pdf. To meet this goal however, the overall bioenergy focused agriculture would require 58.2, 27.3 and 31.7 Tg of N, P₂O₅, and K₂O fertilizers, respectively. This amount corresponds to an overall nutrient fertilizer application increase by a factor of 5.5 over the baseline.

Accordingly, the methods and systems disclosed herein contemplate recovery of phosphorus from an ocean floor, which may be recovered in fish biomass and converted into fertilizers comprising phosphorus. It is contemplated that such methods and systems will contribute to meeting the requirements for global consumption of phosphorus containing fertilizer in the coming years.

Fish biomass can be converted into fertilizers using any method known to one or ordinary skill in the art. See, e.g., U.S. Pat. No. 7,678,171, which discloses processes for preparing fertilizer from fish.

Technical and scientific terms used herein have the meanings commonly understood by one of ordinary skill in the art to which the present systems and methods pertain, unless otherwise defined. Reference is made herein to various methodologies known to one of ordinary skill in the art. Publications and other materials setting forth such known methodologies to which reference is made are incorporated herein by reference in their entireties as though set forth in full. The practice of certain embodiments provided herein will employ, unless otherwise indicated, techniques of chemistry, biology, the aquaculture industry and the algae industry, which are within the skill of the art. Such techniques are explained fully in the literature, e.g., Aquaculture Engineering, Odd-Ivar Lekang, 2007, Blackwell Publishing Ltd.; Handbook of Microalgal Culture, edited by Amos Richmond, 2004, Blackwell Science; Microalgae Biotechnology and Microbiology, E. W. Becker, 1994, Cambridge University Press; Limnology: Lake and River Ecosystems, Robert G. Wetzel, 2001, Academic Press, each of which are incorporated by reference in their entireties.

All references cited herein are incorporated herein by reference in their entirety and for all purposes to the same extent as if each individual publication or patent or patent application was specifically and individually indicated to be incorporated by reference in its entirety for all purposes.

Many modifications and variations of the embodiments provided herein can be made without departing from its spirit and scope, as will be apparent to one or ordinary skill in the art. The specific embodiments described herein are offered by way of example only, and the embodiments are to be limited only by the terms of the appended claims along with the full scope of equivalents to which such claims are entitled.

What is claimed:

1. A controlled method for mixing of carbon dioxide (CO₂) and/or other nutrients in an ocean, said method comprising:
(i) providing an upwelling of a nutrient-rich source of water in the ocean;
(ii) culturing algae in the upwelled water; and
(iii) feeding the algae to fish;
wherein the feeding of the algae to the fish increases the population of the fish in the ocean;
wherein the increase in the population of the fish in the ocean contributes to the mixing of the CO₂ and/or other nutrients in the ocean;
wherein the CO₂ and/or other nutrients are mixed in the ocean.

2. The method of claim 1, wherein the mixing of the CO₂ in the ocean by the fish decreases the concentration of CO₂ at the surface of the ocean and encourages further uptake of atmospheric CO₂ by the ocean.

3. The method of claim 1, wherein the culturing of algae in the upwelled water consumes CO₂ in the water and reduces or slows acidification of the ocean.

4. The method of claim 1, wherein the other nutrients are selected from the group consisting of nitrogen (N), phosphorus (P), potassium (K), silicon (Si), iron (Fe), calcium (Ca), magnesium (Mg), chromium (Cr), selenium (Se), manganese (Mn), nickel (Ni), cobalt (Co), copper (Cu), and zinc (Zn).

5. The method of claim 1, wherein the upwelled water is provided by an open-cycle OTEC system.

6. The method of claim 1, wherein the upwelling of the nutrient-rich source of water further contributes to the mixing of the other nutrients in the ocean.

7. A controlled method for recovery of nutrients from an ocean floor, said method comprising:
providing an upwelling of a nutrient-rich a source of water in the ocean by using an open-cycle OTEC system;
(ii) converting CO₂ into algal biomass in the upwelled water;
(iii) converting the algal biomass into fish biomass; and
(iv) recovering the nutrients from the fish biomass.

8. The method of claim 7, wherein the fish biomass is used to make fish fillets, fish meal, fish oil, biofuel or fertilizer.

9. The method of claim 8, wherein the fish biomass is used make biofuel.

10. The method of claim 9, wherein the biofuel is used to make a liquid fuel selected from the group consisting of diesel, biodiesel, renewable diesel, kerosene, jet-fuel, gasoline, JP-1, JP-4, JP-5, JP-6, JP-7, JP-8, Jet Propellant Thermally Stable (JPTS), a Fischer-Tropsch liquid, an alcohol-based fuel, and a cellulosic biomass-based transportation fuel.

11. The method of claim 8, wherein the fish biomass is used make fish oil.

12. The method of claim 11, wherein the fish oil is used to make omega 3 fatty acids selected from the group consisting of eicosapentaenoic acid (EPA), docosahexaenoic acid (DHA), and derivatives thereof.

13. The method of claim 8, wherein the fish biomass is used to make fertilizer.

14. The method of claim 7, wherein the nutrients recovered from the ocean floor are selected from the group consisting of N, P, K, Si, Fe, Ca, Mg, Cr, Se, Mn, Ni, Co, Cu, and Zn.

15. The method of claim 14, wherein the nutrient recovered from the ocean floor is P.

16. The method of claim 7, wherein decomposition of the algae and fish biomass produces marine snow which recycles the nutrients back to the ocean floor.

17. The method of claim 7, wherein the conversion of CO₂ into algal biomass and/or fish biomass decreases the concentration of CO₂ in the water and reduces or slows acidification of the ocean.

18. The method of claim 1 or 7, wherein the environment of the upwelled water is controlled by monitoring and/or adjusting one or more variables selected from the group consisting of pH, salinity, dissolved oxygen, alkalinity, nutrient concentrations, water homogeneity, temperature, turbidity, algae culture, and fish stock.

19. A controlled system for recovery of nutrients from the ocean floor, said system comprising:
(i) means for providing an upwelling of a nutrient-rich source of water;
(ii) means for culturing algae in the upwelled water;
(iii) means for feeding the algae to fish; and
(iv) means of recovering the nutrients from the fish.

20. The system of claim 19, wherein the means for generating or controlling the upwelled water comprises an open-cycle OTEC system.

21. The system of claim 19, wherein the system further comprises one or more enclosures containing the algae and/or the fish.

22. The system of claim 21, wherein the system further comprises means to monitor and regulate the environment of the enclosures.

23. The system of claim 22, wherein the means to monitor and regulate the environment of the enclosures is selected from the group consisting of means to monitor and/or adjust the pH, salinity, dissolved oxygen, alkalinity, temperature, turbidity, water homogeneity, algae culture, and fish stock, and concentrations of nutrients to the enclosures.
